(19) United States
(12) Patent Application Publication
(10) Pub. No.: US 2008/0206883 A1
(43) Pub. Date: Aug. 28, 2008

(54) HPLC METHOD FOR SEPARATION AND DETECTION OF HYDROMORPHONE AND RELATED OPIOID PHARMACOPHORES

(75) Inventor: Joshua P.L. Black, Cody, WY (US)

Correspondence Address: MERCHANT & GOULD PC, P.O. BOX 2903, MINNEAPOLIS, MN, 55402-0903, US

(73) Assignee: Cody Laboratories, Inc., Cody, WY (US)

(21) Appl. No.: 11/679,128

(22) Filed: Feb. 26, 2007

(51) Int. Cl. G01N 30/02

(52) U.S. Cl. 436/161

(57) ABSTRACT

HPLC methods are provided to separate and detect morphinone, morphine, and dihydromorphine in the presence of hydromorphone. The isocratic HPLC methods employ ion-pair solute-solute ion-exchange mobile phase techniques in reversed phase chromatography. Method conditions in the disclosure provide separation and quantification of opioid pharmacophores in accordance with federal guidelines for obtaining resolution between analytes R≧2.0; tailing factor T≦2.0, capacity factor 2<k′≦50, and theoretical plate number N≧2000 for each opioid analyte peak.

### FIELD OF THE INVENTION

The present invention relates to HPLC methods useful to separate and detect morphinone, morphine, and dihydromorphine in the presence of hydromorphone. The disclosed isocratic HPLC methods employ ion-pair solute-solute ion-exchange mobile phase techniques in reversed phase chromatography.

### BACKGROUND OF THE INVENTION

Morphine, dihydromorphine, hydromorphone and morphinone are structurally related opioid alkaloid pharmacophores. Morphine is extracted from opium and is used as a narcotic analgesic. Dihydromorphine is traditionally prepared by hydrogenation of morphine and is used as also used as a narcotic analgesic. Hydromorphone is traditionally prepared by electrolytic reduction of morphine and is used as a narcotic analgesic as well as a centrally acting narcotic antitussive, which acts directly on the cough reflex center. Morphinone is an impurity found in certain hydromorphone preparations. Morphinone is also a toxic metabolite of morphine (Todaka et al., “Bioactivation of morphine in human liver: isolation and identification of morphinone, a toxic metabolite” Biol. and Pharm. Bull. 28 (2005) 1275-80.). Morphinone can be hepatotoxic (Shimojo and Kumagai, “Possible mechanisms for induction of oxidative stress and suppression of systemic nitric oxide production caused by exposure to environmental chemicals” Environ. Health and Prev. Med., Review. 7: 141-150, (2002)). Thus it is important to be able to detect and quantify morphinone in the presence of morphine, dihydromorphine, and/or hydromorphone.

A synthetic pharmaceutical manufacturing process required separation of all four opioids. A catalytic method of hydromorphone preparation resulted in the presence of morphine, dihydromorphine, and morphinone as minor impurities.

Current literature describes HPLC separation of, for example, morphine and hydromorphone, (e.g. Baeynes et al., “Comparison of morphine and hydromorphone analysis on reversed phase columns with different diameters” J. Pharm. Biomed. Anal. 32 (2003) 913-920); or morphinone and hydromorphone (WO 2005/016930). However, current literature does not provide satisfactory techniques of isocratic HPLC separation and detection of a mixture of four opioid pharmacophores morphine, dihydromorphine, hydromorphone and morphinone, while also meeting federal and international guidelines in terms of recommended resolution (≧2.0), k′ values (≧2.0), theoretical plates (>2000), and tailing factors (≦2.0), among all analytes (International Conference on Harmonization of Technical Requirements for registration of Pharmaceuticals for Human Use (ICH) Guidance for Industry Q3 A (R2) Impurities in New Drug Products. 25 Oct. 2006 and ICH Harmonized Tripartite Guideline; Specifications: Test Procedures and Acceptance Criteria for New Drug Substances and New Drug Products: Chemical Substances Q6A. 6 Oct. 1999). Attempts at routine optimization utilizing standard HPLC techniques (e.g. Lannett Company Test Method #1354-08, Hydromorphone HCl Tablets, USP product release assay) failed to provide adequate separation of each of the four opioid pharmacophores from a mixture.

Thus, a need exists for improved methods of detection and separation of the structurally related opioid pharmacophores morphine, dihydromorphone, and morphinone in preparations of hydromorphone.

### SUMMARY OF THE INVENTION

Isocratic HPLC methods are presented herein to separate and detect morphinone, morphine, and dihydromorphine in the presence of hydromorphone.

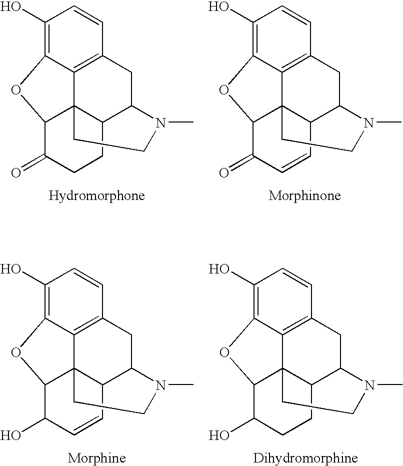

The disclosed HPLC methods employ novel ion-pair solute-solute ion-exchange mobile phase techniques in reversed phase chromatography. Method conditions in the disclosure provide separation of opioid pharmacophores in accordance with federal guidelines for obtaining resolution between analytes R≧2.0; tailing factor T≦2.0, capacity factor 2<k′≦50, and theoretical plate number N≧2000 for each opioid analyte peak (Center for Drug Evaluation and Research (CDER) Reviewer Guidance, Validation of Chromatographic Methods and Guidance for Industry. November 1994, US Pharmacopoeia, General Chapter, Chromatography <621>. Aug. 1, 2006)

In one embodiment, the disclosure provides a method of separating each analyte in a sample mixture of dihydromorphine, morphine, morphinone and hydromorphone, the method comprising: providing a suitable HPLC system fitted with a reversed phase stationary phase column; preparing an isocratic mobile phase comprising an aqueous acidic buffer, an ion exchange compound which comprises the conjugate base of the acid of the aqueous acidic buffer, an ion-pair reagent, and one or more miscible organic solvents; diluting the sample mixture with a diluent weaker or equal in strength to the mobile phase; passing the diluted sample through the HPLC system to separate each analyte; detecting analyte peaks by UV absorbance as each analyte elutes from the column; and processing the analyte peaks to provide a chromatogram; and determine peak height, area, resolution (R), capacity factor (k′), theoretical plates (N), and tailing factor (T) for each analyte peak in the resultant chromatogram; wherein R≧1.5, 2<k′<50, N≧2000, and T≦2 for each analyte peak in the resultant chromatogram.

In one aspect, the reversed phase stationary column is a C18 reversed phase stationary column. In another aspect, the aqueous acidic buffer is selected from an acetic acid buffer and a phosphoric acid buffer. In a specific aspect, the aqueous acidic buffer is an acetic acid buffer. In a further aspect, the ion exchange compound is selected from the group consisting of sodium acetate, ammonium acetate, sodium hydroxide and triethylammonium acetate. In yet another aspect, the ion-pair reagent is selected from the group consisting of butane sulfonic acid sodium salt, decane sulfonic acid sodium salt, dodecane sulfonic acid sodium salt, heptane sulfonic acid sodium salt, hexane sulfonic acid sodium salt, octane sulfonic acid sodium salt, pentane sulfonic acid sodium salt, propane sulfonic acid sodium salt, and sodium dodecyl sulfate (SDS). In a further aspect, the one or more miscible organic solvents is a blend of methanol and acetonitrile.

In a specific embodiment, the mobile phase of the method comprises aqueous acetic acid as the aqueous acidic buffer, sodium acetate as the ion exchange compound, sodium dodecyl sulfate as the ion-pair reagent, and a 1:1 (volume to volume) blend of methanol and acetonitrile as the one or more miscible organic solvents. In one aspect, the method further comprises collecting the analyte peaks as separate fractions as they elute from the HPLC column.

In another embodiment, the disclosure provides a method of quantification of each of the opioid impurities dihydromorphone, morphine, and morphinone in an unknown sample mixture from a preparation of hydromorphone, the method comprising: preparing a series of standard samples, each standard sample comprising a known concentration of each of the four opioids dihydromorphone, morphine, morphinone, and hydromorphone with a diluent weaker than the mobile phase, providing a suitable HPLC system fitted with a reversed phase stationary phase column; preparing an isocratic mobile phase comprising an aqueous acidic buffer, an ion exchange compound which comprises the conjugate base of the acid of the aqueous acidic buffer, an ion-pair reagent, and one or more miscible organic solvents; diluting the unknown sample mixture with a diluent weaker than or equal in strength to the mobile phase; passing the standard samples and the unknown sample through the HPLC system to separate each analyte; detecting analyte peaks from each sample by UV absorbance; processing the analyte peaks to provide a chromatogram for each sample; and determine peak area, peak height, resolution (R), capacity factor (k′), theoretical plates (N), and tailing factor (T) for each analyte peak in the resultant chromatogram; wherein R≧1.5, 2<k′<50, N≧2000, and T≦2 for each analyte peak; using the chromatograms from the standard samples to prepare a standard concentration curve of peak area or peak height vs. time for each opioid; wherein the standard concentration curve is linear with % RSD<10% and r²>0.99; and comparing the peak area or peak height for each analyte peak from the unknown sample to the linear portion of the standard concentration curve to determine a concentration of each opioid in the unknown sample.

In one aspect of the method, the reversed phase stationary column is a C18 reversed phase stationary column. In another aspect, the aqueous acidic buffer is selected from an acetic acid buffer and a phosphoric acid buffer. In a specific aspect, the aqueous acidic buffer is an acetic acid buffer. In one aspect of the method, the ion exchange compound is selected from the group consisting of sodium acetate, ammonium acetate, sodium hydroxide and triethylammonium acetate. In a further aspect of the method, the ion-pair reagent is selected from the group consisting of butane sulfonic acid sodium salt, decane sulfonic acid sodium salt, dodecane sulfonic acid sodium salt, heptane sulfonic acid sodium salt, hexane sulfonic acid sodium salt, octane sulfonic acid sodium salt, pentane sulfonic acid sodium salt, propane sulfonic acid sodium salt, and sodium dodecyl sulfate (SDS). In another aspect of the method, the one or more miscible organic solvents is a blend of methanol and acetonitrile. In a further aspect of the method, the mobile phase of the method comprises aqueous acetic acid as the aqueous acidic buffer, sodium acetate as the ion exchange compound, sodium dodecyl sulfate as the ion-pair reagent, and a 1:1 (volume to volume) blend of methanol and acetonitrile as the one or more miscible organic solvents. In one aspect, the wavelength of detected UV absorbance is selected from the range of about 220 nm to about 285 nm. In a specific aspect of the method, the wavelength of detected UV absorbance is 280 nm.

In another embodiment, the disclosure provides a method of separating each analyte in a sample mixture including two or more of dihydromorphine, morphine, morphinone and hydromorphone, the method comprising: providing a suitable HPLC system fitted with a reversed phase stationary phase column; preparing an isocratic mobile phase comprising an aqueous acidic buffer, an ion-pair reagent, and one or more miscible organic solvents; diluting the sample mixture with a diluent weaker than or equal in strength to the mobile phase; passing the diluted sample through the HPLC system thereby separating each analyte; detecting the analyte peaks from each sample by UV absorbance; and analyzing the analyte peaks in the resultant chromatogram.

In one aspect of the method, the isocratic mobile phase further comprises an ion exchange compound which comprises the conjugate base of the acid of the aqueous acidic buffer. In another aspect of the method, the analyzing step comprises: processing the analyte peaks to provide a chromatogram; and processing the analyte peaks further to determine peak height, area, resolution (R), capacity factor (k′), theoretical plates (N), and tailing factor (T) for each analyte peak in the chromatogram. In a further aspect of the method, R≧1.5, 2<k′<50, N≧2000, and T≦2 for each analyte peak in the chromatogram.

### BRIEF DESCRIPTION OF THE FIGURES

FIG. 1 shows an reversed phase HPLC chromatogram of a sample mixture of morphine, dihydromorphone, morphinone, and hydromorphone when subjected to a mobile phase comprising an ion-pair reagent, and an ion exchange buffer salt in aqueous acetic acid/methanol/acetonitrile as described in Example 1.

FIG. 2 shows four reversed phase HPLC chromatograms at four different concentrations of morphine, dihydromorphone, morphinone, in the presence of 0.5 mg/mL hydromorphone according to Example 5. These HPLC data were used to prepare calibration curves shown in FIGS. 3-6.

FIG. 3 shows a calibration curve report for external standard analysis of 0.56 to 2.8 micrograms/mL dihydromorphine in the presence of 0.5 milligram/mL hydromorphone as described in Example 5. For linear curve type, response factor % RSD was 3.326% and correlation coefficient (r²) was 0.9996.

FIG. 4 shows a calibration curve report for external standard analysis of 0.50 to 2.5 micrograms/mL morphine in the presence of 0.5 milligram/mL hydromorphone as described in example 5. For linear curve type, response factor % RSD was 1.579% and correlation coefficient (r²) was 0.9995.

FIG. 5 shows a calibration curve report for external standard analysis of 0.4 to 2.0 micrograms/mL morphinone in the presence of 0.5 milligram/mL hydromorphone as described in Example 5. For linear curve type, response factor % RSD was 10.31% and correlation coefficient (r²) was 0.998.

FIG. 6 shows a calibration curve report for external standard analysis of a single concentration at 0.5 milligram/mL hydromorphone as described in Example 5. For linear curve type, response factor % RSD was 1.128% and correlation coefficient (r²) was 0.9995.

FIG. 7 shows a chromatogram of minor amounts of morphine and morphinone in the presence of about 0.5 milligrams/mL of hydromorphone as described in Example 6.

### DETAILED DESCRIPTION OF THE INVENTION

Chromatographic methods are commonly used for the quantitative and qualitative analysis of raw materials, drug substances, drug products and compounds in biological fluids. The objective of a test method is to generate reliable and accurate data regardless of whether the test is for acceptance, release, stability or pharmacokinetics study.

High performance liquid chromatography (HPLC) is a separation technique based on interaction and differential partition of the sample between mobile liquid phase and the stationary phase. A liquid mobile phase is pumped through the stationary phase column, typically at relatively high pressure. A sample mixture is prepared and injected to the HPLC system and travels through the stationary phase. The sample components are separated based on relative affinity for the mobile phase, the stationary phase and the other sample components.

An HPLC system typically includes at least an HPLC column packed with a suitable stationary phase, a mobile phase; one or more pumps for directing the mobile phase through the stationary phase; and a detector for detecting the presence of compounds eluting from the column.

An HPLC system may be used in two modes. The HPLC system may be used in an analytical mode to detect and quantify compounds in a sample, and the system may be used in a preparative mode to physically separate compounds in a sample after elution from the column.

Two typical stationary phases include ion exchange and reversed phase column packings. Ion exchange (IE) chromatography separation is used to separate charged analytes based on charge-bearing groups; anion exchange for sample negative ion (X−), or cation exchange for sample positive ion(X+). Gradient elution by pH is common.

In reversed phase (RP) chromatography the mobile phase is more polar than the stationary phase. RP stationary phases are usually used to separate neutral, hydrophobic analytes. The RP hydrophobic bonded-phase chromatographic technique uses aqueous solvents or a combination of aqueous/miscible organic solvents for the mobile phase. Generally, more polar components elute faster than less polar components. Ion-pair (IP) chromatography is an alternative to ion exchange chromatography for the separation of charged analytes. The stationary phases used are the same reversed phases as developed for reversed phase chromatography. An ionic organic compound, which forms an ion-pair with a sample component of opposite charge, is added to the mobile phase. This ion-pair is, chemically speaking, a salt which behaves chromatographically like a non-ionic organic molecule that can be separated by reversed phase chromatography. When used with common hydrophobic HPLC phases in the reversed-phase mode, ion-pair reagents can be used to selectively increase the retention of charged analytes. The advantages of ion-pair chromatography over ion exchange are improved peak shape and highly reproducible results.

An isocratic elution in HPLC is defined as a separation in which the mobile phase composition remains unaltered. The mobile phase in an isocratic elution may be a single solvent, or a pre-mixed mixture of solvents.

A gradient elution in HPLC is one in which the composition of the mobile phase is varied during the separation. Typically in a gradient elution, two or three solvents that differ in polarity are employed.

A reference standard is a highly purified compound that is well characterized.

Detection limit is the lowest concentration of an analyte in a sample that can be detected, but not necessarily quantitated, under the stated experimental conditions.

Quantitation limit is the lowest concentration of analyte that can be determined with acceptable precision and accuracy under the stated experimental conditions.

Validation of a method is the process by which a method is tested by the developer or user for reliability, accuracy and preciseness of its intended purpose.

The linear range of detectability that obeys Beer's Law is dependent on the compound analyzed and detector used. The working sample concentration and samples tested for accuracy should be in the linear range. When monitoring impurity peaks expressed as percent area of the parent drug substance, the impurity observed may not be a true reflection of the theoretical amount if the non-linear section of the concentration curve is employed. In addition, the actual amount will be obtained only if the extinction coefficient or absorptivity values are the same for both impurity and parent compound. Therefore impurity reference standards are often employed.

An external standard method is used when the standard is analyzed on a separate chromatogram from the sample. Quantitation is based on a comparison of the peak area/height of the sample to that of a reference standard of the analyte of interest. In one embodiment of the disclosure, an external standard method may be employed to quantitate each opioid pharmacophore.

With an internal standard method, a compound of known purity that does not cause interference in the analysis is added to the sample mixture. Quantitation is based on the response ratio of compound of interest to the internal standard vs. the response ratio of a similar preparation of the reference standard.

Sample detection in HPLC can be based on ultraviolet (UV) detection of the sample components as they elute from the column. In one embodiment of the disclosure, a UV detector is used to monitor sample elution from the HPLC column. The UV detector may be a single wavelength UV detector, a dual wavelength UV detector, or a photodiode array (PDA) detector. A photodiode array detector can be used to detect a range of wavelengths; data from one or more monitored wavelengths may be processed by the PDA. In one aspect of the disclosure, the UV detector is a Varian Prostar 330 PDA detector. In a further aspect of the invention, minimum wavelength monitored by the UV detector is 220 nm and the maximum wavelength monitored by the UV detector is 400 nm. In one aspect of the invention, any single UV wavelength selected between 220 nm and 285 nm is monitored and processed for detection of sample elution. In a specific aspect, the single UV wavelength monitored for detection of compounds is 280 nm.

System suitability testing is performed on an HPLC system to assure the accuracy and precision of HPLC data collected. System suitability specifications and tests are used to help assist with achieving the desired level of accuracy and precision. Accuracy is the measure of how close the experimental value is to the true value. Precision is the measure of how close the data values are to each other for a number of measurements under the same analytical conditions.

In one aspect of the disclosure, definition of terms for system suitability parameters are explained in Center for Drug Evaluation and Research (CDER) Reviewer Guidance Validation of Chromatographic Methods, November 1994, CMC3. (http://www.fda.gov/CDER/GUIDANCE/cmc3.pdf).

In another aspect of the disclosure, systems suitability parameters are defined in Varian Workstation HPLC software and are defined briefly below.

Capacity factor, k′, is used to describe the migration rate of an analyte on a column. The capacity factor for analyte A is defined as;

k′_{A}=(t_{R}−t₀)−1

where t_{R} and t₀ are obtained from a chromatogram. t_{R} is the retention time of the analyte peak of interest, which is the time between sample injection and the analyte peak reaching a detector at the end of the column. t₀ is called the void volume, which is the time taken for the mobile phase to pass through the column. CDER generally recommends that the capacity factor k′>2. In one aspect of the disclosure, the capacity factor for an analyte is between about 2 and about 50.

Precision, or injection repeatability, is expressed as relative standard deviation (RSD). For example, the RSD for a single concentration of a single analyte over several injections may be calculated by taking the standard deviation of the parent peak area counts and dividing by the average of the parent peak area counts. % RSD is determined by dividing the standard deviation by the mean for the same set and then multiplying by 100%. % RSD is a measure of the reproducibility of an analysis. The % RSD indicates the performance of the HPLC system at the time the samples are analyzed. CDER recommends a RSD≦1% for n≧5. In one aspect of the disclosure, the RSD is ≦2%.

R² is the square of the correlation coefficient which represents the relative strength of the model.

Relative retention (a) describes the separation of two species (A and B) on the column;

α=k′_{B}/k′_{A}

When calculating the relative retention, species A elutes faster than species B. The relative retention is always greater than one; preferably greater than or equal to 1.5, and optimally greater than or equal to 2.

Resolution (R) is a measure of how well two peaks are separated. For reliable quantitation, it is essential that two peaks are well separated.

R=2(t_{R2}−t_{R1})/(1.699(W₁+W₂))

where t_{R1} is the retention time of the analyte peak of interest and t_{R2} is the retention time of the next peak. W₁ is the peak width at half height for the peak at t_{R1}. W₂ is the peak width at half height for peak at t_{R2}. CDER recommends optimal R of >2 between the peak of interest and the closest potential interfereing peak. In a broad embodiment, R>1.5; in one aspect of the disclosure, R≧2 for each analyte peak of interest.

For optimal separations, chromatographic peaks should be sharp and symmetrical with minimal peak broadening. In optimizing separation it is helpful to measure the efficiency of the chromatographic column.

Theoretical plates, also called efficiency plates, are a measure of column efficiency, the number of theoretical plates in a column is termed N and the more plates the better the efficiency of the column. The number of theoretical plates in a real column can be found by examining a chromatographic peak after elution.

N=5.5452(t_{R}/W₁)²=L/H

where t_{R} is the retention time of the analyte, W₁ is the peak width at half height for the peak at t_{R1}. N is fairly constant for each individual peak on a chromatogram with a fixed set of operating conditions. H, or HETP, the height equivalent of a theoretical plate, measures the column efficiency per unit length (L) of the column. Parameters which can affect N or H include peak position, particle size in column, flow-rate of mobile phase, column temperature, viscosity of mobile phase, and molecular weight of the analyte. CDER generally recommends N>2000. In one aspect of the disclosure, N≧2000 for each analyte peak of interest.

Peak symmetry is measured at, for example, 10% of peak height where A is the distance from peak front to peak maximum and B is the distance from peak maximum to peak end. Symmetry=B/A. Ideally, symmetry should be 1. Peak tailing occurs where symmetry>1, and peak fronting occurs when symmetry<1.

The tailing factor (T) is defined as follows:

T=(TT−TL)/(2(t_{R}−TL))

where TT is the retention time of trailing peak edge at 5% or 10% from the baseline of the peak height, and TL is the retention time of the leading edge at 5% or 10% from the baseline of the peak height. t_{R} is the retention time of the analyte peak of interest. In one aspect, TT and TL are calculated at 5% from the baseline of peak height. CDER recommends a T of ≦2. In one aspect of the disclosure, T≦2.

Unless otherwise specified, the term hydromorphone includes both the hydromorphone free base and any salt form of hydromorphone that can be formed, including any pharmaceutically acceptable salt of hydromorphone, for example, hydromorphone hydrochloride. The pharmaceutically acceptable salts can include anhydrous forms and hydrous forms, for example monohydrates and dihydrates. Likewise, the terms morphinone, morphine, and dihydromorphine each include both the free base forms and any salt forms, hydrous, or anhydrous forms of these opioid pharmacophores.

The disclosed HPLC methods employ ion-pair solute-solute ion-exchange mobile phase techniques in reversed phase chromatography. Method conditions in the disclosure provide separation of opioid pharmacophores in accordance with federal guidelines for obtaining resolution between analytes R≧2.0; tailing factor T≦2.0, capacity factor 2<k′≦50, and theoretical plate number N≧2000 for each opioid analyte peak. System suitability is performed by three replicate injections of standard on experiments prior to spiked injections. Consistent analyte retention time and area count response is monitored for acceptability of results reported.

In one embodiment of the disclosure, the stationary phase is a reversed phase stationary phase. Various reversed phase column packings typically include a SiO₂-based core derivitized with hydrophobic organic groups. These organic groups include phenyl derivatives and carbon chain derivatives of various lengths such as four carbon, (C4), 8 carbon (C8) and 18 carbon (C18) derivatives. In one embodiment of the disclosure, the reversed phase solid phase stationary column is selected from a C4, C8, C18, or phenyl stationary phase. In one aspect of the disclosure, the RP stationary phase is a C18 RP column. In a specific aspect of the disclosure, for example, the column is Waters Symmetry® C18, with column dimensions 4.6×150 mm internal diameter, with 5 μm particle size. Other factors to consider in the stationary phase column are column dimensions, particle size, pore size and pump pressure. These may be varied by techniques known to those skilled in the art in accordance with sample scale to enhance resolution and various other suitability parameters.

In one embodiment, the HPLC column is fitted with a guard column. The guard column serves as a pre-filter in line immediately prior to the column on the HPLC system. Use of a guard column will prolong the useful life of the column. The guard column is typically packed with a frit containing a small amount of the same, or similar, solid phase material as the column. In one aspect, the HPLC system is fitted with a guard column. In another aspect, the HPLC system is run without a guard column.

In one embodiment, HPLC column temperatures may be varied. In one aspect, column temperatures may be varied from 30° C. to 50° C. In disclosed HPLC method conditions, a lower column temperature results in a slight increase in resolution as well as enhanced column preservation. In a specific aspect, a 30° C. column temperature is employed.

In one embodiment, the HPLC method is an analytical method. In one aspect, the disclosed HPLC method is an analytical method used to separate a sample mixture of two or more of morphine, dihydromorphine, hydromorphone, and morphinone. In another aspect, minor amounts of one or more of morphine, dihydromorphine, and morphinone are detected and quantified in the presence of a major amount of hydromorphone. In this aspect, for example, about 0.5 microgram per milliliter (μg/mL) of one or more opioid impurity morphine, dihydromorphine, and morphinone are detected and quantified in the presence of about 0.5 milligram per mL (mg/mL) of hydromorphone. In one aspect of the disclosure, the opioid pharmacophores may be present in a hydromorphone crude or purified synthetic preparation, a drug substance, or drug product or any pharmaceutical dosage form. In another aspect, the opioid pharmacophores may be present in a biological sample. The biological sample may comprise plant matter, animal tissue, blood, serum, plasma, urine, bile, sputum or feces.

In another embodiment, the HPLC method is a preparative method. In one aspect, the disclosed HPLC method is a preparative method used to physically separate a sample mixture of two or more of morphine, dihydromorphine, hydromorphone, and morphinone.

A known or unknown sample containing two or more of morphine, dihydromorphine, hydromorphone, and morphinone is diluted in a sample diluent. In one embodiment, a sample diluent of the same or weaker organic strength than the mobile phase may be employed. The term weaker means a lower organic solvent concentration is used in the diluent than in the mobile phase. In one example, a sample diluent consisting of a mixture of water, methanol (MeOH), and acetic acid (HOAc) at a volume ratio of 95:5:1, is employed to fully solubilize the sample. In another example, the mobile phase itself may be used as diluent. In one aspect, the sample is sonicated after partial dilution, then diluted to a specific volume. In another aspect, the diluted sample is optionally filtered through a 0.45 μm filter, treated by solid phase extraction, or otherwise pretreated by techniques known to one skilled in the art to remove precipitated or aggregated material impurities.

In one embodiment, a flow rate of the mobile phase through the column of 0.001 up to 3,200 mL per minute may be employed, depending on the scale of the HPLC system. In one aspect, a flow rate for a microanalytical system is from about 0.01 to about 0.5 mL per minute. In a further aspect, a flow rate of from about 0.5 to about 2 mL per minute may be employed for an analytical scale HPLC system. In another aspect, a flow rate of from about 2 mL per minute to about 10 mL per minute may be employed in a semi-preparative HPLC system. In another aspect, the flow rate for a preparative scale HPLC system may range from about 5 to about 3,200 mL/minute. In one aspect, the HPLC system is an analytical HPLC system. In a further aspect, the flow rate is 1.2 mL per minute.

In one embodiment of the disclosure, the mobile phase strength may be adjusted in terms of varying the percent of organic solvent in the mobile phase. In one aspect the percent organic in the mobile phase is selected from between about 10% to about 40% organic solvent. In a further aspect the organic phase is 20% of the mobile phase when the HPLC method is used in an isocratic mode. In another embodiment, the strength of the organic solvent may be adjusted by blending organic solvents, so long as each solvent employed is miscible in the mobile phase employed. In one aspect, solvent blending of acetonitrile (ACN) and methanol (MeOH) is employed to enhance separation of the two critical pairs of opioid analytes (dihydromorphine-morphine and morphinone-hydromorphone). In one aspect of the disclosure, a blend of 1:1 ACN/MeOH is employed as the organic phase in the mobile phase. In another embodiment of the disclosure, an amine modifier may optionally be employed in the mobile phase. Amine modifiers are selected from, for example, triethylamine or diisopropylamine.

In one embodiment of the disclosure, the HPLC separation is run in isocratic mode or gradient mode. In one aspect, the HPLC separation is run in an isocratic mode.

In another embodiment of the invention, the pH of the mobile phase is selected from about pH 2.6 to about pH 4.6. In one aspect, the mobile phase is selected from about pH 3.6 to about pH 3.9

In one embodiment, the mobile phase concentration of ion-pair reagent and buffer salt ion exchange compound concentration are iterated to optimize k′. In one embodiment of the disclosure, a decrease in ion-pair reagent is combined with a counterion ion-exchange process to utilize a conjugate acid-base buffer pair to decrease k′. The buffer concentration may be adjusted to within about one unit of the pKa of the buffer system chosen. In one aspect embodiment, as illustrated in the examples presented below, iteration of ion-pair reagent concentration and ion-exchange buffers in the mobile phase serve to separate the four opioid analytes of interest with acceptable resolution, k′ values, absent fronting peaks, and acceptable tailing factors.

In one embodiment of the invention, the ion-pair reagent is selected from one or more of butane sulfonic acid sodium salt, decane sulfonic acid sodium salt, dodecane sulfonic acid sodium salt, heptane sulfonic acid sodium salt, hexane sulfonic acid sodium salt, octane sulfonic acid sodium salt, pentane sulfonic acid sodium salt, propane sulfonic acid sodium salt, and sodium dodecyl sulfate (SDS). In a specific aspect, the ion-pair reagent is sodium dodecyl sulfate. In another aspect of the disclosure, the ion-pair reagent is heptane sulfonic acid sodium salt. In one aspect, the concentration of the ion-pair reagent in the mobile phase is selected from within the range of about 5 mM to about 50 mM. In a further aspect, the concentration of the ion-pair reagent in the mobile phase is selected within the range of from about 20 mM to about 40 mM in the mobile phase.

In one embodiment of the disclosure, the aqueous buffer system/buffer salt ion exchange compound is selected from acetic acid/sodium acetate and phosphoric acid/monobasic sodium monophosphate buffer systems. In another aspect, an acetic acid aqueous buffer system may also be paired with one or more of triethylammonium acetate or ammonium acetate as salt/ion exchange compounds. In a further aspect, sodium hydroxide may optionally be used to adjust pH or sodium ion concentration. In addition to monobasic sodium monophosphate, monobasic potassium phosphate monophosphate, mono- or diammonium phosphate buffer salt/ion exchange compounds may be employed with phosphoric acid. In a preferred aspect, the ion exchange buffer/buffer salt ion exchange compound in the mobile phase is an acetic acid/sodium acetate buffer system.

In a specific aspect of the disclosure, for example, acceptable resolution of all four opioid analytes is found with isocratic mobile phase 23 mM sodium dodecyl sulfate, 0.23 M acetic acid, 17.7 mM sodium acetate in water/ACN/MeOH at 80:10:10 ratio (v/v/v), about pH 3.7; column temperature 30° C.; flow rate 1.2 mL/min; with sample detection at 280 nm; stationary phase Waters Symmetry® C18, 5 μm, 150×4.6 mm column; sample diluent of 95:5:1 (H₂O:MeOH:HOAc); autosampler wash of 80:20 (H₂O:IPA); injection volume 5-100 uL; and sample concentration variable ˜(0.3-1.0 mg/mL). It was found that opioid analyte peak resolution (≧2.0), with a maximum k′ value of ˜25, and tailing values ≦2.0, as well as theoretical plates were acceptable with this method. Detection of morphinone was linear as low as 0.04% (0.4 μg/mL or 0.0004 mg/mL) relative to the 0.5 mg/mL hydromorphone parent peak with an r² value of 0.99 at levels tested. This result suggests that a validated limit of quantitation is possible at levels less than, or equal to, 0.05 percent for opioid impurities in various hydromorphone preparations. An increased concentration of the parent hydromorphone peak will allow lower levels of detection.

### EXAMPLES

The following reagents and instrumentation were used in the examples. In general, the HPLC was run in an isocratic mode utilizing the mobile phase specified in each example. The column was washed between runs with a gradient of 5-75-5% methanol in water. Equilibration and wash chromatograms were typically monitored both preceding and following each run.

Multiple isocratic mobile phases were prepared using acetic acid or phosphoric acid aqueous buffers, ion-pair reagents sodium dodecyl sulfate or 1-heptane sulfonic acid, varying concentration of ion-pair reagent in aqueous portion of mobile phase, e.g. from 10 mM to 50 mM SDS, ion exchange reagents sodium acetate or sodium dihydrogen phosphate, with sodium acetate in varying concentrations from 11 to 44 mM in the aqueous portion of the mobile phase, organic solvents used in mobile phase from 10 to 40% of volume of mobile phase, and presence or absence of triethylamine as an amine modifier. Selected examples are reported below.

### Reagents:

Sodium Dodecyl Sulfate (SDS) Ultra Pure for HPLC,
1-Heptane Sulfonic Acid Sodium salt, monohydrate, for HPLC,
Sodium Acetate Anhydrous (NaOAc), puriss, p.a. for HPLC,
Sodium Dihydrogen Phosphate, anhydrous, for HPLC
Glacial Acetic Acid (HOAc), HPLC grade,
Phosphoric Acid, 85% w/v, HPLC grade,
Sodium Hydroxide, 97+%, ACS grade,
Acetonitrile (ACN), HPLC grade,
Methanol (MeOH), HPLC grade,
Milli-Q H₂O,
Isopropyl Alcohol (IPA),
Hydromorphone base(HM),
Hydromorphone HCl (HM),
Morphinone base(MN),
Morphine base(MR),
Dihydromorphine base(DH).

### Instruments:

Varian HPLC modules: Photodiode Array (PDA) Model 330, Solvent Delivery Model 240, Autosampler Model 240, Column Valve Model 500, HPLC Processing Software Varian Star LC WS Version 6.
Balance, Mettler AE 50
pH meter: Hanna Instruments

### EXAMPLE 1

HPLC separation of dihydromorphine, morphine, morphinone and hydromorphone was performed via isocratic HPLC with a mobile phase utilizing ion-exchange processes coupled with reverse phase ion-pair chromatography reagent sodium docecyl sulfate (SDS).

Opioid samples were prepared in a semi-quantitative fashion for co-injection. The sample mixture contained dihydromorphine, morphine, morphinone and hydromorphone. Opioids as free bases were weighed individually and diluted to 10 mL with diluent (water, methanol, and acetic acid (HOAc: 95:5:1, v/v). As prepared, hydromorphone was 1.02 mg/mL, dihydromorphine was 0.33 mg/mL, morphine was 1.08 mg/mL, and morphinone 0.2 mg/mL. Aliquots were then qualitatitively combined at ˜25%/each into 1.5 mL autosampler vial for injections.

The mobile phase was prepared by combining sodium dodecyl sulfate (SDS, 60 g) with milliQ water (7200 mL) for a 28.9 mM SDS buffer solution. Next, a 50:50 organic blend of methanol:acetonitrile (1800 mL) was added and the solution mixture was degassed well and stirred until the SDS was fully dissolved. To a 1200 mL aliquot of the 80:20, buffer/organic solution mixture was added acetic acid (glacial, 20 mL), followed addition of sodium acetate (2.178 g). The mobile phase was degassed well until bubbles absent and all NaOAc fully dissolved. The pH was measured at pH 3.74 (target pH 3.7) in presence of organic.
Method parameters for Example 1:
Column: Waters Symmetry C18, 4.6×150 mm ID, 5 μm particle size
Flow Rate: 1.2 mL/min.
Wavelength: 280 nm
Column Temperature: 30° C.
Diluent: 95:5:1 (H₂O:MeOH:HOAc)
Autosampler Wash: 80:20 (H₂O:isopropyl alcohol)
Injection Volume: 100 μL

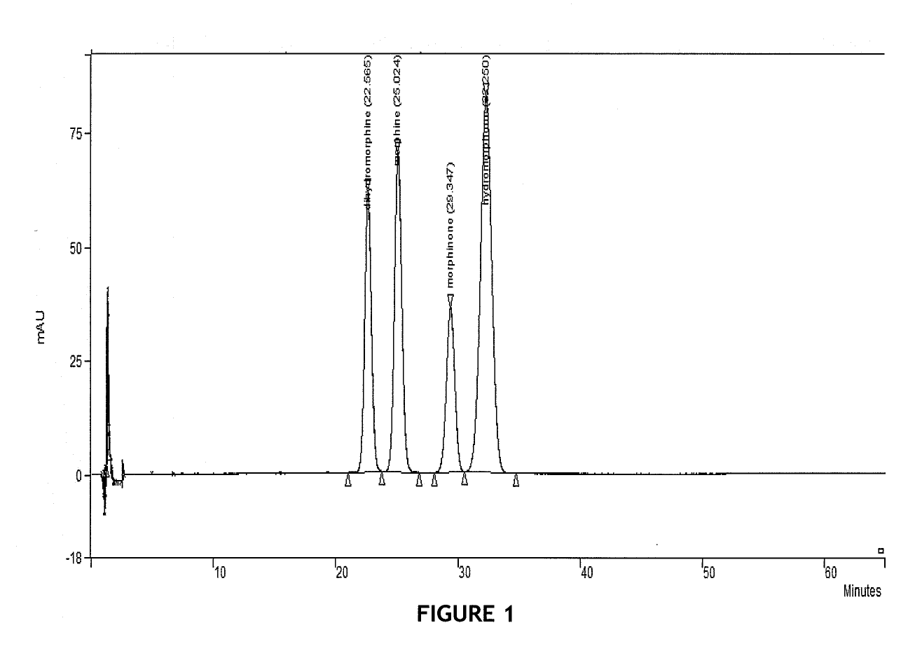

The chromatogram for this example is shown in FIG. 1. Data for Example 1 are shown in Tables 1 and 2. Table 1 shows data from the chromatogram.

TABLE 1

| | | | Ret. | | Rel | | Width |
|---|---|---|---|---|---|---|---|
| Peak | | | Time | Area | Ret | | ½ |
| No | Peak Name | Result ( ) | (min) | (counts) | Time | Sep. Code | (sec) |
| 1 | dihydromorphine | 18.8487 | 22.540 | 11942699 | 0.00 | BB | 35.5 |
| 2 | morphine | 23.7658 | 25.009 | 15058217 | 0.00 | BB | 39.2 |
| 3 | morphinone | 14.0926 | 29.325 | 8929206 | 0.00 | BB | 45.2 |
| 4 | hydromorphone | 43.2928 | 32.225 | 27430676 | 0.00 | BB | 60.7 |
| | Totals | 99.9999 | | 63360796 | | | |

Table 2 shows processed data for each suitability parameter. Please note that efficiency plates is the same as theoretical plates.

TABLE 2

| Peak | tR | Sep. | Efficiency | | | Tailing |
|---|---|---|---|---|---|---|
| Name | (min) | Code | Plates | k′ | R | (5.0%) |
| Dihydromorphine | 22.539 | BB | 8038 | 21.54 | 2.8 | 1.07 |
| Morphine | 25.009 | BB | 8109 | 24.01 | 2.8 | 1.07 |
| Morphinone | 29.325 | BB | 8388 | 28.33 | 1.9 | 0.99 |
| Hydromorphone | 32.225 | BB | 5623 | 31.22 | 1.9 | 1.01 |

Although coupling the mobile phase system showed acceptable results for all parameters tested, i.e. R≧1.5, 2<k′<50, N≧2000, and T≦2 for each analyte peak, additional experiments were performed to achieve a decreased k′.

### EXAMPLE 2

HPLC separation of dihydromorphine, morphine, morphinone and hydromorphone was performed with various SDS concentrations in the mobile phase. HPLC mobile phases were prepared with SDS concentration at 10 mM, 20 mM, 25 mM, and 50 mM SDS in aqueous portion of mobile phase. Otherwise mobile phase utilized 80:20 aqueous buffer (SDS, AcOH)/50:50 organic, ACN:MeOH. Briefly, to a 1200 mL aliquot of the SDS concentration adjusted 80:20, buffer/organic solution mixture was added acetic acid (glacial, 20 mL), followed addition of sodium acetate (2.178 g). The mobile phase was degassed well until bubbles absent and all NaOAc fully dissolved. The pH was measured. Method parameters for Examples 2a to 2d are the same as described in example 1.

### EXAMPLE 2a

A 10 mM SDS buffer solution was prepared and mobile phase pH was measured at 3.15. Use of 10 mM SDS resulted in peak broadening and increased k′ such that the four compounds did not completely elute before the end of the 60-minute run time. Data not shown.

### EXAMPLE 2b

A 20 mM SDS buffer solution was prepared with mobile phase pH 2.96. Results are shown in Table 3.

TABLE 3

| Peak | tR | Sep. | Efficiency | | | Tailing |
|---|---|---|---|---|---|---|
| Name | (min) | Code | Plates | k′ | R | (5.0%) |
| Dihydromorphine | 51.355 | BB | 10089 | 50.36k′, | 2.8 | 1.09 |
| Morphine | 57.575 | BB | 9661 | 56.57k′, | 2.8 | 1.25 |
| Morphinone | 72.125 | BB | 10578 | 71.13k′, | 5 from morphine, | 1.01 |

| | |
|---|---|
| Hydromorphone | 75+, eluted after the run was finished. |

### EXAMPLE 2c

A 25 mM SDS buffer solution was prepared and mobile phase pH was measured at 3.1. Results are shown in Table 4.

TABLE 4

| Peak | tR | Sep. | Efficiency | | | Tailing |
|---|---|---|---|---|---|---|
| Name | (min) | Code | Plates | k′ | R | (5.0%) |
| Dihydromorphine | 30.969 | BB | 8714 | 28.92 | 2.4 | 1.08 |
| Morphine | 34.240 | BB | 8857 | 32.12 | 2.4 | 1.07 |
| Morphinone | 40.581 | BB | 9340 | 38.32 | 2.2 | 1.01 |
| Hydromorphone | 44.879 | BB | 8262 | 42.21 | 2.2 | 1.12 |

### EXAMPLE 2d

A 50 mM SDS buffer solution was prepared and mobile phase pH was measured at 3.1. Results are shown in Table 5.

TABLE 5

| Peak | tR | Sep. | Efficiency | | | Tailing |
|---|---|---|---|---|---|---|
| Name | (min) | Code | Plates | k′ | R | (5.0%) |
| Dihydromorphine | 15.769 | BB | 6368 | 14.77 | 1.5 | 1.03 |
| Morphine | 16.999 | BB | 6375 | 16.00 | 1.5 | 1.08 |
| Morphinone | 19.157 | BB | 6599 | 18.16 | 1.8 | 1.01 |
| Hydromorphone | 20.964 | BB | 6409 | 19.96 | 1.8 | 1.07 |

Examples 2a to 2d showed an increase in SDS concentration resulted in a decrease in k′ and a concomitant decrease in resolution under conditions listed. The mobile phase systems at 25 and 50 mM SDS in the aqueous portion of the mobile phase under these conditions showed showed acceptable results for all parameters tested, i.e. R≧1.5, 2<k′<50, N≧2000, and T≦2 for each analyte peak.

### EXAMPLE 3

HPLC Separation of dihydromorphine, morphine, morphinone and hydromorphone was performed with various organic concentrations in the mobile phase. HPLC mobile phases were prepared with varying organic concentration at 20%, 25%, and 30% of mobile phase. HPLC method parameters were the same as Example 1 with different mobile phases. The opioid sample was the same as in Example 1.

Each mobile phase was prepared in a similar fashion to those previously described with 25 mM SDS, 27.54 mM NaOAc, and 291 mM AcOH in the aqueous portion of the mobile phase, with organic concentration from 20%, 25% and 30% 50:50, ACN:MeOH, respectively.

### EXAMPLE 3a

A 20% organic mobile phase was prepared as described. pH was measured at pH 3.70. Results are shown in Table 6.

TABLE 6

| Peak | tR | Sep. | Efficiency | | | Tailing |
|---|---|---|---|---|---|---|
| Name | (min) | Code | Plates | k′ | R | (5.0%) |
| Dihydromorphine | 25.973 | BB | 8367 | 24.97 | 2.5 | 1.05 |
| Morphine | 28.987 | BB | 8433 | 27.99 | 2.5 | 1.10 |
| Morphinone | 34.387 | BB | 8770 | 33.39 | 2.0 | 1.00 |
| Hydromorphone | 37.970 | BB | 5401 | 36.97 | 2.0 | 0.96 |

### EXAMPLE 3b

A 25% organic mobile phase was prepared as described. Results are shown in Table 7.

TABLE 7

| Peak | tR | Sep. | Efficiency | | | Tailing |
|---|---|---|---|---|---|---|
| Name | (min) | Code | Plates | k′ | R | (5.0%) |
| Dihydromorphine | 24.740 | BB | 9222 | 23.74 | 2.7 | 1.05 |
| Morphine | 27.710 | BB | 9299 | 26.71 | 2.7 | 1.09 |
| Morphinone | 33.713 | BB | 9815 | 32.71 | 2.1 | 1.01 |
| Hydromorphone | 37.329 | BB | 4956 | 36.33 | 2.1 | 0.90 |

### EXAMPLE 3c

A 30% organic mobile phase was prepared as described. Results are shown in Table 8.

TABLE 8

| Peak | tR | Sep. | Efficiency | | | Tailing |
|---|---|---|---|---|---|---|
| Name | (min) | Code | Plates | k′ | R | (5.0%) |
| Dihydromorphine | 22.607 | BB | 9415 | 21.61 | 2.7 | 1.03 |
| Morphine | 25.253 | BB | 9566 | 24.25 | 2.7 | 1.04 |
| Morphinone | 31.151 | BB | 10153 | 30.15 | 2.0 | 0.98 |
| Hydromorphone | 34.516 | BB | 4400 | 33.52 | 2.0 | 0.84 |

The mobile phase systems at 20%, 25% and 30% organic under these conditions showed acceptable results for all parameters tested, i.e. R≧1.5, 2<k′<50, N≧2000, and T≦2 for each analyte peak, although a slight hydromorphone peak fronting was witnessed with an increase to 30% organic in the mobile phase under these conditions.

### EXAMPLE 4

HPLC Separation of dihydromorphine, morphine, morphinone and hydromorphone was performed with various sodium acetate concentrations in the mobile phase.

Four HPLC mobile phases were prepared with varying sodium acetate concentrations 11, 22, 33 and 44 mM sodium acetate in mobile phase consisting of 80:20 aqueous (28.9 mM SDS, 291 mM AcOH)/organic (50:50 methanol/acetonitrile). The pH was held constant at pH 3.65.

HPLC method parameters were the same as Example 1 with different mobile phases. The opioid sample was prepared in a similar fashion to that described in Example 1.

### EXAMPLE 4a

A mobile phase was prepared as described with 11 mM sodium acetate. pH was measured at pH 3.65. Results are shown in Table 9.

TABLE 9

| Peak | tR | Sep. | Efficiency | | | Tailing |
|---|---|---|---|---|---|---|
| Name | (min) | Code | Plates | k′ | R | (5.0%) |
| Dihydromorphine | 18.929 | BB | 6985 | 17.93 | 1.8 | 1.07 |
| Morphine | 20.649 | BB | 7028 | 19.65 | 1.8 | 1.06 |
| Morphinone | 23.345 | BB | 7212 | 22.35 | 1.9 | 1.01 |
| Hydromorphone | 25.677 | BB | 5473 | 24.68 | 1.9 | 1.03 |

### EXAMPLE 4b

A mobile phase was prepared as described with 22 mM sodium acetate. pH was measured at pH 3.65. Results are shown in Table 10.

TABLE 10

| Peak | tR | Sep. | Efficiency | | | Tailing |
|---|---|---|---|---|---|---|
| Name | (min) | Code | Plates | k′ | R | (5.0%) |
| Dihydromorphine | 15.630 | BB | 6515 | 14.63 | 1.8 | 1.05 |
| Morphine | 17.083 | BB | 6649 | 16.08 | 1.8 | 1.05 |
| Morphinone | 19.388 | BB | 6808 | 18.39 | 1.7 | 0.99 |
| Hydromorphone | 21.282 | BB | 4774 | 20.28 | 1.7 | 0.98 |

### EXAMPLE 4c

A mobile phase was prepared as described with 33 mM sodium acetate. pH was measured at pH 3.65. Results are shown in Table 11.

TABLE 11

| Peak | tR | Sep. | Efficiency | | | Tailing |
|---|---|---|---|---|---|---|
| Name | (min) | Code | Plates | k′ | R | (5.0%) |
| Dihydromorphine | 13.247 | BB | 6163 | 12.25 | 1.8 | 1.04 |
| Morphine | 14.481 | BB | 6289 | 13.48 | 1.8 | 1.06 |
| Morphinone | 16.500 | BB | 6516 | 15.50 | 1.7 | 0.99 |
| Hydromorphone | 18.093 | BB | 4253 | 17.09 | 1.7 | 0.93 |

### EXAMPLE 4d

A mobile phase was prepared as described with 44 mM sodium acetate with pH 3.65. Results are shown in Table 12.

TABLE 12

| Peak | tR | Sep. | Efficiency | | | Tailing |
|---|---|---|---|---|---|---|
| Name | (min) | Code | Plates | k′ | R | (5.0%) |
| Dihydromorphine | 11.507 | BB | 6110 | 10.51 | 1.7 | 1.04 |
| Morphine | 12.572 | BB | 6266 | 11.57 | 1.7 | 1.05 |
| Morphinone | 14.376 | BB | 6538 | 13.38 | 1.6 | 0.99 |
| Hydromorphone | 15.752 | BB | 4090 | 14.75 | 1.6 | 0.91 |

The mobile phase systems at 11 to 44% sodium acetate under these conditions showed acceptable results for all parameters tested, i.e. R≧1.5, 2<k′<50, N≧2000, and T≦2 for each analyte peak. An increase in sodium acetate concentration resulted in a decrease of k′ with a slight decrease in R. Theoretical plates and tailing factors were found to be acceptable at all concentrations of sodium acetate. Hydromorphone peak fronting was increased at higher sodium acetate concentrations in the chromatograms.

### EXAMPLE 5

HPLC calibration curves for dihydromorphine, morphine, and morphinone in the presence of hydromorphone were developed.

Two concentrations of ion-pair reagent sodium dodecyl sulfate (SDS) were used in two different mobile phase preparations to determine linearity in HPLC detection of dihydromorphine, morphine, and morphinone standard samples at four concentration levels in the presence of 0.5 mg/mL parent hydromorphone peak. The linear range of quantitation for standard opioid samples was used to help assess limit of quantitation.
Method parameters:
Column: Waters Symmetry C18 4.6×150 mm ID, 5 μm particle size
Flow Rate: 1.2 mL/min
Wavelength: 280 nm
Temperature: 30° C.
Mobile phase/buffer: See below
Sample diluent: 95:5:1 (H₂O:MeOH:HOAc)
Autosampler wash: 80:20 (H₂O:IPA)
Injection volume: 100 μL

HPLC mobile phases were prepared as follows.

Mobile phase I: SDS (10 g) was combined with 1200 mL milliQ H₂O, then 300 mL of 50:50, ACN:MeOH was added to provide about 28.9 mM SDS. The solvent mixture was degassed and stirred until all SDS was fully dissolved. Acetic acid (20 mL) was first added to the 1500 mL solvent mixture, followed by addition of NaOAc (2.178 g, 26.55 mmol). The mobile phase I was pH 3.81 in presence of organic.

Mobile phase II: SDS (10 g, 34.7 mmol) was combined with 800 mL H₂O, then 200 mL of 50:50 ACN:MeOH was added. The solvent mixture was degassed and stirred until all SDS was fully dissolved. Acetic acid (8.33 mL) was added to 1000 mL mobile phase, followed by addition of NaOAc (904 mg, 11.0 mmol). The mobile phase was degassed well until bubbles absent and NaOAc was fully dissolved. The mobile phase II was pH 3.83 in presence of organic.

Stock samples for HPLC quantitation were prepared. Hydromorphone related opioid pharmacophore substance stock solutions were carefully weighed into 1.5 mL vials, then diluted, and thoroughly rinsed into a single 500 mL volumetric flask. Diluent was 95:5:1 H₂O/MeOH/HOAc. Aliquots were removed using Class A glassware pipettes.

The morphinone related substance stock solution was prepared by weighing 2.0 mg (2.0452 gi-2.0472 gf) and dilution to 500 mL with diluent for a total concentration of 4 μg/mL. The limit of detection and/or quantitation for morphinone samples prepared at the following concentrations:
1 mL stock into 10 mL volumetric: 0.4 μg/mL morphinone (0.08% of HM concentration at 0.5 mg/mL);
2 mL stock into 10 mL volumetric: 0.8 μg/mL morphinone (0.16% of HM concentration at 0.5 mg/mL);
3 mL stock into 10 mL volumetric: 1.2 μg/mL morphinone (0.24% of HM concentration at 0.5 mg/mL);
5 mL stock into 10 mL volumetric: 2.0 μg/mL morphinone (0.40% of HM concentration at 0.5 mg/mL).

The morphine related substance stock solution was prepared by weighing 2.5 mg (2.0769 gi-2.0794 gf) and dilution to 500 mL with diluent for a total concentration of 5 μg/mL. The limit of detection and/or quantitation for morphine samples prepared at the following concentrations:
1 mL stock into 10 mL volumetric: 0.5 μg/mL morphine (0.10% of HM concentration at 0.5 mg/mL);
2 mL stock into 10 mL volumetric: 1.0 μg/mL morphine (0.20% of HM concentration at 0.5 mg/mL);
3 mL stock into 10 mL volumetric: 1.5 μg/mL morphine (0.25% of HM concentration at 0.5 mg/mL);
5 mL stock into 10 mL volumetric: 2.0 μg/mL morphine (0.50% of HM concentration at 0.5 mg/mL).

The dihydromorphine related substance stock solution was prepared by weighing 2.8 mg (2.0741 gi-2.0769 gf) and dilution to 500 mL with diluent for a total concentration of 5.6 μg/mL The limit of detection and/or quantitation for dihydromorphine samples prepared at the following concentrations (Note that trace amounts of dihydromorphine may be present in parent peak hydromorphone. However, main concern in this experiment was morphinone detections in presence of hydromorphone):
1 mL stock into 10 mL volumetric: 0.56 μg/mL dihydromorphine (0.10% of parent HM concentration at 0.5 mg/mL);
2 mL stock into 10 mL volumetric: 1.12 μg/mL dihydromorphine (0.20% of HM concentration at 0.5 mg/mL);
3 mL stock into 10 mL volumetric: 1.68 μg/mL dihydromorphine (0.25% of HM concentration at 0.5 mg/mL);
5 mL stock into 10 mL volumetric: 2.8 μg/mL dihydromorphine (0.50% of HM concentration at 0.5 mg/mL).

The hydromorphone stock solution prepared from Cody Laboratories, Inc. lot 010-BN-151 which was previously analyzed for morphinone (which was not detected) by the HPLC. This lot of hydromorphone was produced from a different process that did not contain morphinone as an impurity. Sample used to make the limit of quantitation/detection samples weighed 51.0 mg (50 mL volumetric flask zeroed) and was diluted to 50 mL with 95:5:1 (H₂O:MeOH:HOAc) diluent. Aliquots (5 mL) were taken from this HM stock solution, using class A graduated glass pipettes, into 10 mL volumetric flasks containing related substance aliquots. Following dilution of related substance samples and diluent to 10 mL, the final concentration of standard samples was 0.51 mg/mL of hydromorphone.

Use of HPLC mobile phase I for separation of hydromorphone with four concentration levels of related opioid impurities showed a % RSD≦10% and r² value of 0.99 at levels tested. Level 1 parameter results for the stock solution consisting of dihydromorphine 2.8 ug/mL, morphine 2.0 ug/mL, morphinone 2.0 ug/mL, and hydromorphone 0.5 mg/mL are shown in Table 13.

TABLE 13

| Peak | tR | Sep. | Efficiency | | | Tailing |
|---|---|---|---|---|---|---|
| Name | (min) | Code | Plates | k′ | R | (5.0%) |
| Dihydromorphine | 29.317 | BB | 12516 | 28.32 | 2.9 | N/A |
| Morphine | 32.610 | BB | 11893 | 31.61 | 2.9 | 0.85 |
| Morphinone | 38.997 | BB | 12807 | 38.00 | 2.1 | 0.72 |
| Hydromorphone | 42.747 | BB | 6451 | 41.75 | 2.1 | 1.20 |

Results at the four concentration levels tested were used to determine the following: dihydromorphine % RSD=8.96 and r² value of 0.99; morphine % RSD=7.64 and r² value of 0.99; morphinone % RSD=9.41 and and r² value of 0.99; and hydromorphone % RSD=0.99 at single level and and r² value of 0.99. The same experiment was then performed utilizing mobile phase 2 to reduce k′ for each analyte.

Level 1 parameter results for the stock solution consisting of dihydromorphine 2.8 ug/mL, morphine 2.0 ug/mL, morphinone 2.0 ug/mL, and hydromorphone 0.5 mg/mL are shown in Table 14. FIG. 1 shows chromatograms 1, 2, 3 and 4, of four concentrations of HM related substances from top (level 1) to bottom (level 4) with mobile phase II.

TABLE 14

| Peak | tR | Sep. | Efficiency | | | Tailing |
|---|---|---|---|---|---|---|
| Name | (min) | Code | Plates | k′ | R | (5.0%) |
| Dihydromorphine | 18.947 | BB | 9948 | 17.95 | 2.3 | 1.31 |
| Morphine | 20.712 | BB | 12176 | 19.71 | 2.3 | 1.06 |
| Morphinone | 23.383 | BB | 11162 | 22.38 | 2.0 | N/A |
| Hydromorphone | 25.662 | BB | 5630 | 24.66 | 2.0 | 1.12 |

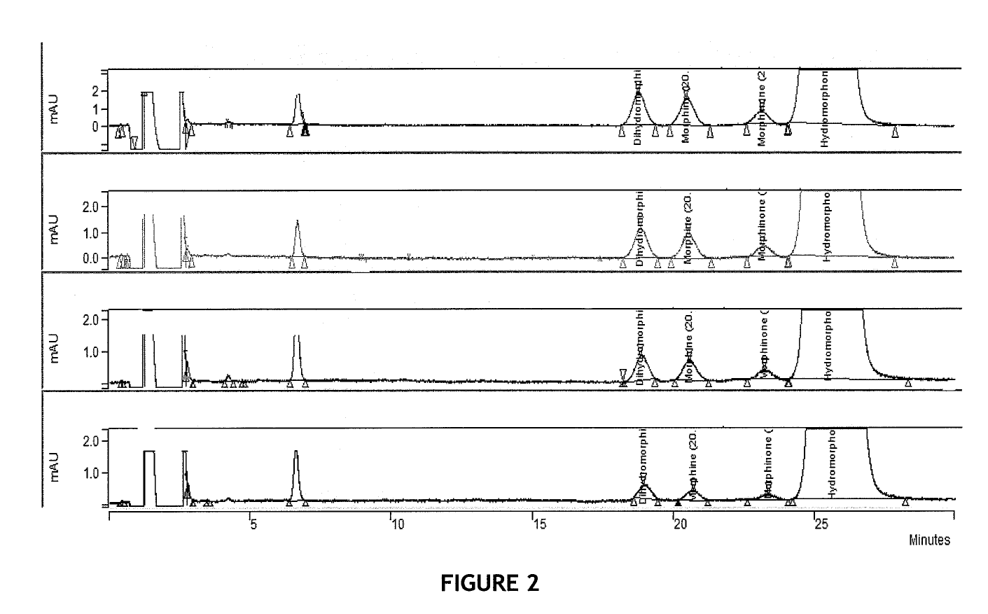

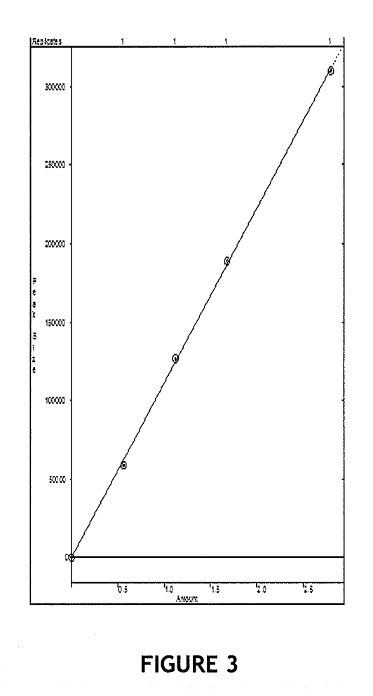

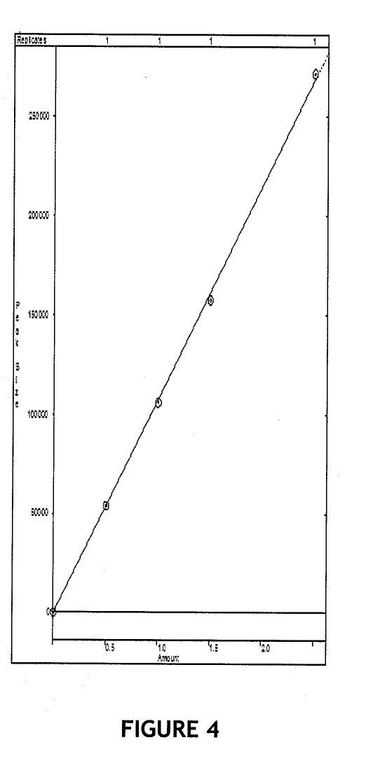

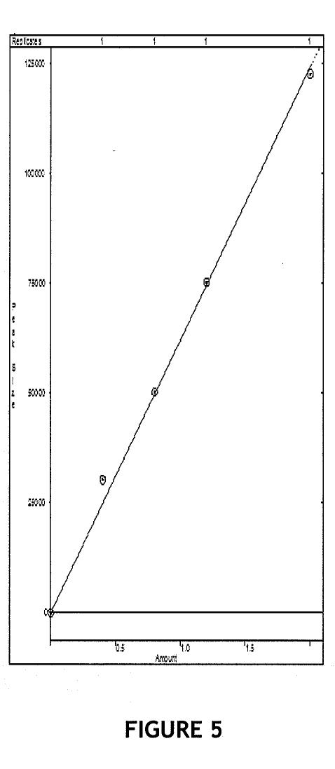

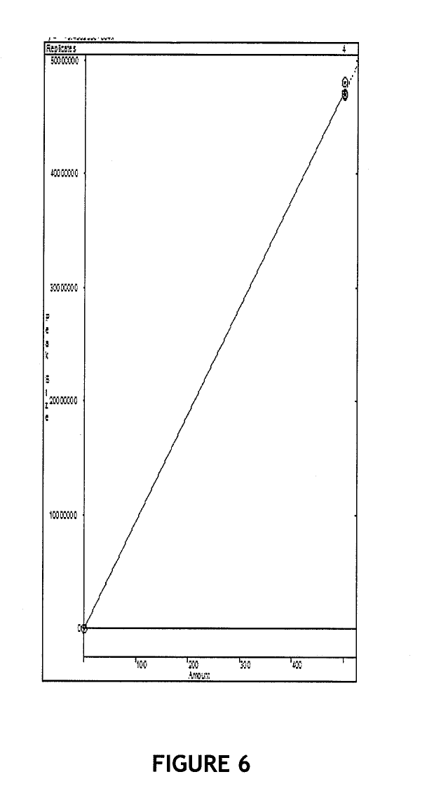

Use of HPLC mobile phase II for separation of hydromorphone related opioid impurities in the same standard samples prepared reduced k′ for each analyte. Use of HPLC mobile phase II also showed a % RSD≦10% and r² value of 0.99 at concentration levels tested for each opioid. FIG. 2 shows the four calibration chromatograms arranged representative of highest to lowest levels of concentrations of related substances from top (level 1) to bottom (level 4) with mobile phase II. Calibration curves corresponding to each opioid are shown in FIGS. 3-6. According to the calibration curves shown, opioid samples of dihydromorphine, morphine, or morphinone at concentrations of 0.5 microgram per mL or above should be within both the limits of detection and the limits of quantitation in the presence of about 0.5 mg/mL hydromorphone.

### EXAMPLE 6

The HPLC method was used to detect opioid impurities in the presence of hydromorphone.

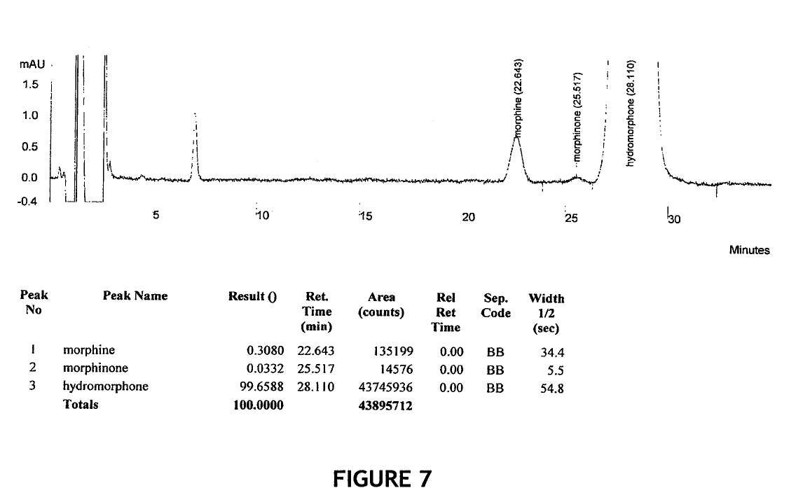

Samples were subjected to isocratic HPLC to detect the presence of dihydromorphine, morphine, and morphinone at unknown concentration levels in the presence of about 0.5 mg/mL parent hydromorphone. The mobile phase was the same as mobile phase II in Example 5 for these isocratic HPLC runs. HPLC method parameters were as described in Example 1. An example chromatogram is shown in FIG. 7. Morphinone was detected at 0.03 to 0.04% of area counts compared to samples semi-quantitatively prepared at 0.5 mg/mL of hydromorphone parent peak. Morphine was detected in the sample chromatogram shown in FIG. 7 at about 0.31% area of the parent hydromorphone peak. No dihydromorphine was detected in this sample.

While the present invention has generally been described in relation to an analytical HPLC method of detection and separation of two or more opioid pharmacophores dihydromorphine, morphine, morphinone, and hydromorphone, the teachings provided herein may also be applied to other aspects of HPLC chromatography. For example, methods prescribed herein may easily be modified in scale by one skilled in the art to apply to preparative HPLC methods of separation of two or more of these opioid pharmacophores. Likewise the methods described herein may be applied to other opioid alkaloid pharmacophores not specifically described. Moreover, while various embodiments of the present invention have been described in detail, it is apparent that modifications and adaptations of those embodiments will occur to those skilled in the art. However, it is to be expressly understood that such modifications and adaptations are within the spirit and scope of the present invention.

I claim:

1. A method of separating each analyte in a sample mixture of dihydromorphine, morphine, morphinone and hydromorphone, the method comprising:
a. providing a suitable HPLC system fitted with a reversed phase stationary phase column;
b. preparing an isocratic mobile phase comprising an aqueous acidic buffer, an ion exchange compound which comprises the conjugate base of the acid of the aqueous acidic buffer, an ion-pair reagent, and one or more miscible organic solvents;
c. diluting the sample mixture with a diluent weaker or equal in strength to the mobile phase;
d. passing the diluted sample through the HPLC system to separate each analyte;
e. detecting analyte peaks by UV absorbance as each analyte elutes from the column; and
f. processing the analyte peaks to provide a chromatogram; and determine peak height, area, resolution (R), capacity factor (k′), theoretical plates (N), and tailing factor (T) for each analyte peak in the resultant chromatogram; wherein
R≧1.5, 2<k′<50, N≧2000, and T≦2 for each analyte peak in the resultant chromatogram.

2. The method of claim 1 wherein the reversed phase stationary column is a C18 reversed phase stationary column.

3. The method of claim 2 wherein the aqueous acidic buffer is selected from one or more of an acetic acid buffer and a phosphoric acid buffer.

4. The method of claim 3 wherein the aqueous acidic buffer is an acetic acid buffer.

5. The method of claim 4 wherein the ion exchange compound is selected from one or more of the group consisting of sodium acetate, ammonium acetate, sodium hydroxide and triethylammonium acetate.

6. The method of claim 5 wherein the ion-pair reagent is selected from one or more of the group consisting of butane sulfonic acid sodium salt, decane sulfonic acid sodium salt, dodecane sulfonic acid sodium salt, heptane sulfonic acid sodium salt, hexane sulfonic acid sodium salt, octane sulfonic acid sodium salt, pentane sulfonic acid sodium salt, propane sulfonic acid sodium salt, and sodium dodecyl sulfate (SDS).

7. The method of claim 6 wherein the one or more miscible organic solvents is a blend of methanol and acetonitrile.

8. The method of claim 7 wherein the mobile phase comprises aqueous acetic acid as the aqueous acidic buffer, sodium acetate as the ion exchange compound, sodium dodecyl sulfate as the ion-pair reagent, and a 1:1 (volume to volume) blend of methanol and acetonitrile as the one or more miscible organic solvents.

9. The method of claim 7 wherein the method further comprises
collecting the separated analytes as separate fractions.

10. A method of quantification of each of the opioid impurities dihydromorphone, morphine, and morphinone in an unknown sample mixture from a preparation of hydromorphone, the method comprising:
a. preparing a series of standard samples, each standard sample comprising a known concentration of each of the four opioids dihydromorphone, morphine, morphinone, and hydromorphone with a diluent weaker than the mobile phase;
b. providing a suitable HPLC system fitted with a reversed phase stationary phase column;
c. preparing an isocratic mobile phase comprising an aqueous acidic buffer, an ion exchange compound which comprises the conjugate base of the acid of the aqueous acidic buffer, an ion-pair reagent, and one or more miscible organic solvents;
d. diluting the unknown sample mixture with a diluent weaker than or equal in strength to the mobile phase;
e. passing the standard samples and the unknown sample through the HPLC system to separate each analyte;
f. detecting analyte peaks from each sample by UV absorbance;
g. processing the analyte peaks to provide a chromatogram for each sample; and determine peak area, peak height, resolution (R), capacity factor (k′), theoretical plates (N), and tailing factor (T) for each analyte peak in the resultant chromatogram;
wherein R≧1.5, 2<k′<50, N≧2000, and T≦2 for each analyte peak;
h. using the chromatograms from the standard samples to prepare a standard concentration curve of peak area or peak height vs. time for each opioid; wherein the standard concentration curve is linear with % RSD<10% and r²>0.99; and
i. comparing the peak area or peak height for each analyte peak from the unknown sample to the linear portion of the standard concentration curve to determine a concentration of each opioid in the unknown sample.

11. The method of claim 10 wherein the reversed phase stationary column is a C18 reversed phase stationary column.

12. The method of claim 11 wherein the aqueous acidic buffer is selected from an acetic acid buffer and a phosphoric acid buffer.

13. The method of claim 12 wherein the aqueous acidic buffer is an acetic acid buffer.

14. The method of claim 13 wherein the ion exchange compound is selected from the group consisting of sodium acetate, ammonium acetate, sodium hydroxide and triethylammonium acetate.

15. The method of claim 14 wherein the ion-pair reagent is selected from the group consisting of butane sulfonic acid sodium salt, decane sulfonic acid sodium salt, dodecane sulfonic acid sodium salt, heptane sulfonic acid sodium salt, hexane sulfonic acid sodium salt, octane sulfonic acid sodium salt, pentane sulfonic acid sodium salt, propane sulfonic acid sodium salt, and sodium dodecyl sulfate (SDS).

16. The method of claim 15 wherein the one or more miscible organic solvents is a blend of methanol and acetonitrile.

17. The method of claim 16 wherein the mobile phase comprises aqueous acetic acid as the aqueous acidic buffer, sodium acetate as the ion exchange compound, sodium dodecyl sulfate as the ion-pair reagent, and a 1:1 (volume to volume) blend of methanol and acetonitrile as the one or more miscible organic solvents.

18. The method of claim 17 wherein the wavelength of detected UV absorbance is selected from the range of about 220 nm to about 285 nm.

19. The method of claim 18 wherein the wavelength of detected UV absorbance is 280 nm.

20. A method of separating each analyte in a sample mixture including two or more of dihydromorphine, morphine, morphinone and hydromorphone, the method comprising:
a. providing a suitable HPLC system fitted with a reversed phase stationary phase column;
b. preparing an isocratic mobile phase comprising an aqueous acidic buffer, an ion-pair reagent, and one or more miscible organic solvents;
c. diluting the sample mixture with a diluent weaker than or equal in strength to the mobile phase;
d. passing the diluted sample through the HPLC system thereby separating each analyte;
e. detecting the analyte peaks from each sample by UV absorbance; and
f. analyzing the analyte peaks in the resultant chromatogram.

21. The method of claim 20 wherein the isocratic mobile phase further comprises an ion exchange compound which comprises the conjugate base of the acid of the aqueous acidic buffer.

22. The method of claim 21 wherein the analyzing step comprises:
a. processing the analyte peaks to provide a chromatogram; and
c. processing the analyte peaks further to determine peak height, area, resolution (R), capacity factor (k′), theoretical plates (N), and tailing factor (T) for each analyte peak in the chromatogram.

23. The method of claim 20 wherein
R≧1.5, 2<k′<50, N≧2000, and T≦2 for each analyte peak in the chromatogram.
